(19) United States
(12) Patent Application Publication
(10) Pub. No.: US 2004/0044586 A1
(43) Pub. Date: Mar. 4, 2004

(54) Online refund method

(76) Inventors: John Gullo, Alexandria, VA (US); Carrie A. Bornitz, Alexandria, VA (US); Mary Beth Fluto, Washington, DC (US)

Correspondence Address: WEISS & MOY PC, 4204 NORTH BROWN AVENUE, SCOTTSDALE, AZ, 85251, US

(21) Appl. No.: 10/651,529

(22) Filed: Aug. 29, 2003

Related U.S. Application Data
(60) Provisional application No. 60/407,418, filed on Aug. 29, 2002.

(51) Int. Cl. G06F 17/60

(52) U.S. Cl. 705/26; 705/14

(57) ABSTRACT

An online method for processing refund requests. In a preferred embodiment, the method is utilized for postage transactions, including particularly unused postage evidenced by information based indicia that has been purchased online. The IBI evidencing the postage is linked with a tracking/label number and preferably also a transaction number, so as to minimize fraud or other misuse of the refund method.

### RELATED APPLICATION

This non-provisional application claims priority from provisional application No. 60/407,418, filed on Aug. 29, 2002.

### FIELD OF THE INVENTION

The present invention relates to a method of processing refunds online, including, in one embodiment, for processing refunds for unused postage.

### BACKGROUND OF THE INVENTION

With the advent and wider use of the Internet, many products that traditionally have been sold in face-to-face transactions have been made available in an online setting. As an example, the PC Postage™ service was introduced by the U.S. Postal Service (“USPS”) and used by commercial companies for making convenient postage payment transactions on the web or through other methods.

PC Postage™ products provide enhanced customer convenience with the ability to print Information Based indicia (“IBI”) postage from a personal computer, 24 hours a day, 7 days a week. Customers do not have to worry about running out of postage or making late night runs to the post office. In many cases, customers can print labels with PC Postage™ service utilizing an address book which provides cleansing of the address by USPS standards. This helps ensure more timely and accurate delivery. Depending on the product being used, bar codes are added to track the mail or verify delivery. This technology made mailing easier.

However, this technology currently does not provide the same convenience when it comes to getting a refund for unused labels, whether one has changed their mind about mailing the letter or package or inadvertently used the wrong delivery address. The current regulations require that all unused IBI must be returned to the PC Postage™ Provider (“PPP”) in order to receive a refund. This regulation is expensive for both the customer (they have to pay the postage cost to mail in the unused IBI) and the PPP (they have to spend work hours to validate and process the refund request).

An online refund policy would benefit customers through ease of use and the provider through reduced processing costs. The major challenge is to substantiate the same level of security and integrity in an online process as there is in the current manual process. The present solution was developed to eliminate, as much as possible, the potential for abuse or fraudulent activity. Although the current process cannot eliminate these types of activities 100%, this process is perceived to be secure and minimizes abuse and fraud.

Because mail pieces with IBI are not tracked through the postal processing systems, it is impossible to identify in most instances if a customer were to duplicate an IBI. This makes it nearly impossible to detect reuse of this type of postage. Although the postal service randomly tests IBI on items in the mailstream, it is primarily to check that the indicia is valid and the applied postage amount is correct for the product and weight of the package.

On the other hand, there are specific mail products and services that contain tracking numbers and can be identified with a very high degree of certainty if the item was deposited and processed in the USPS mailstream. All of these products contain a unique tracking number that is scanned by the Postal Service at one or several points in the handling process. If these unique tracking numbers were tied to a unique IBI, it would be feasible to identify whether the postage was used.

Although neither the current process nor the online process can guarantee 100% that a label will not be duplicated, linking a unique tracking number and IBI provides the ability to monitor any fraudulent activities. This method of monitoring postage can be construed as more secure than current systems because it automatically tracks each IBI by its accompanying tracking number.

The present invention is directed to, in one embodiment, an online postage refund process that will automatically track label/indicia usage and validate both approvals for refunds and monitor fraudulent use of labels. This systematic approach makes it unnecessary to require users to mail in their unused labels.

### BRIEF DESCRIPTION OF THE DRAWINGS

FIG. 1 is a flow diagram, consistent with an embodiment of the present invention, indicating possible steps that a user seeking a refund for unused postage might follow.

FIG. 2 is a flow diagram, indicating an embodiment of a refund method for unused postage, consistent with the present invention.

FIG. 3 is a flow diagram, consistent with an embodiment of the present invention, illustrating an appeal process component of an online refund method consistent with the present invention.

### DETAILED DESCRIPTION OF THE INVENTION

The present invention is concerned with a method for providing, through an online system, a refund to a user. In one preferred embodiment, the refund relates to a purchase of postage occurring online.

With regard to the postage refund embodiment, there are several basic elements to such a method. First, there needs to be a sale of postage to a user. Typically, the postage sold will be evidenced by IBI on the shipping label, that will be printed out by the user and affixed to an article that is to be mailed. In a preferred embodiment, such sale occurs online, though it may occur in a different manner. An additional element is, preferably, the provision of a tracking number, (also referred to as a “label” number) that will be linked with, and that can thereby identify, particular IBI that has been provided to the user. Additionally, it is preferred to assign a unique transaction number to each online purchase transaction, which transaction number will be linked with, and can thereby identify, particular IBI purchased during such transaction. (Where more than one item of postage is purchased in a transaction, the same transaction number will refer to each IBI purchased during such transaction. The tracking/label number associated with IBI will remain unique.) A user seeking a refund relating to the purchase of postage evidenced by particular IBI will provide the tracking/label number as evidence of the purchase, and in order to obtain a refund. Preferably, the user is also required to provide the transaction number associated with such purchase, as part of the refund process. The refund step occurs via an online system.

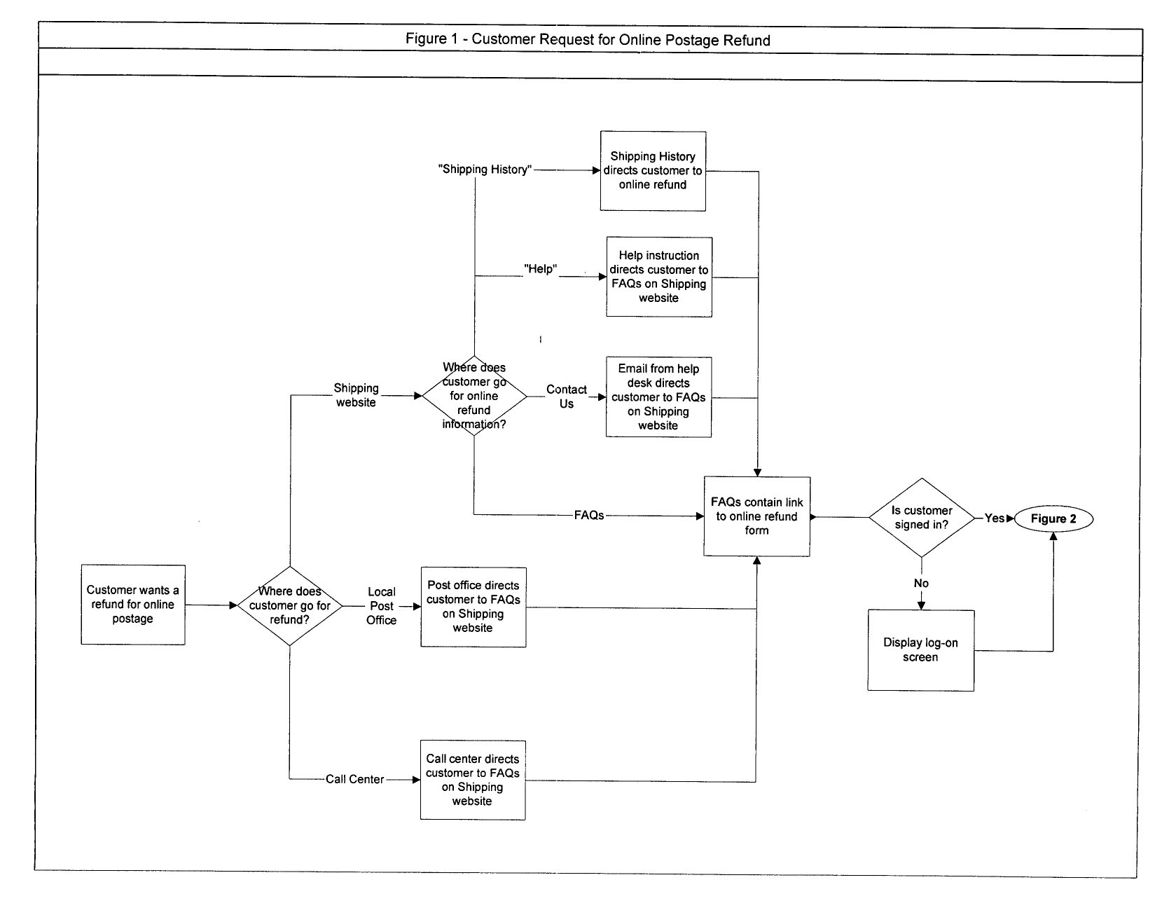

To facilitate this process, an interface screen for refund requests is desired. The screen should prompt the user to input information sufficient to verify the identity of the user and the validity of the request. As described in FIG. 1, a user/customer seeking a refund for unused postage may seek such refund through an online method, as an alternative to visiting a local post office. Preferably, persons inquiring about obtaining a refund at the local post office or via telephone can be advised to obtain such a refund online, as illustrated in FIG. 1.

Upon initiating such a process online, the user may be provided the option of reviewing the customer's shipping history, of obtaining “help” regarding the refund process, and/or of contacting the refunding authority via e-mail. A customer continuing with the process should be prompted to sign-in/log-on, and typically will be prompted to provide a user ID and password.

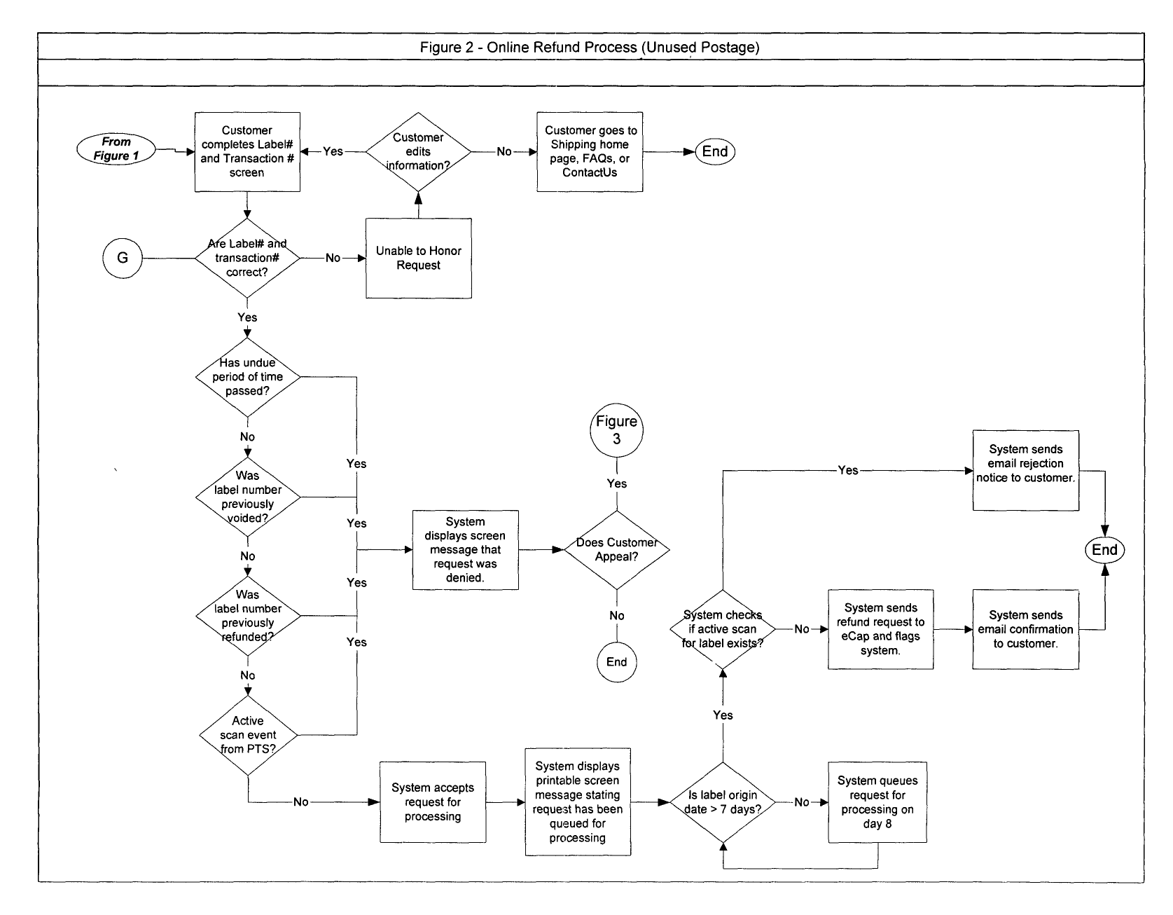

Referring now to FIG. 2, the refund process continues beyond the initial log-on step. The system should prompt the customer to provide identifying information concerning the postage transaction for which a refund is sought. The information sought preferably includes a tracking/label number and transaction number associated therewith. (It should be noted that provision of either the tracking number or transaction number could be sufficient. Moreover, it should be noted further that the tracking number and/or transaction number could be incorporated into the IBI and it's use could be sufficient.) If the identifying information provided is not correct, the customer should be notified that the refund request cannot be processed, and preferably is given an opportunity to edit the information provided and resume the process.

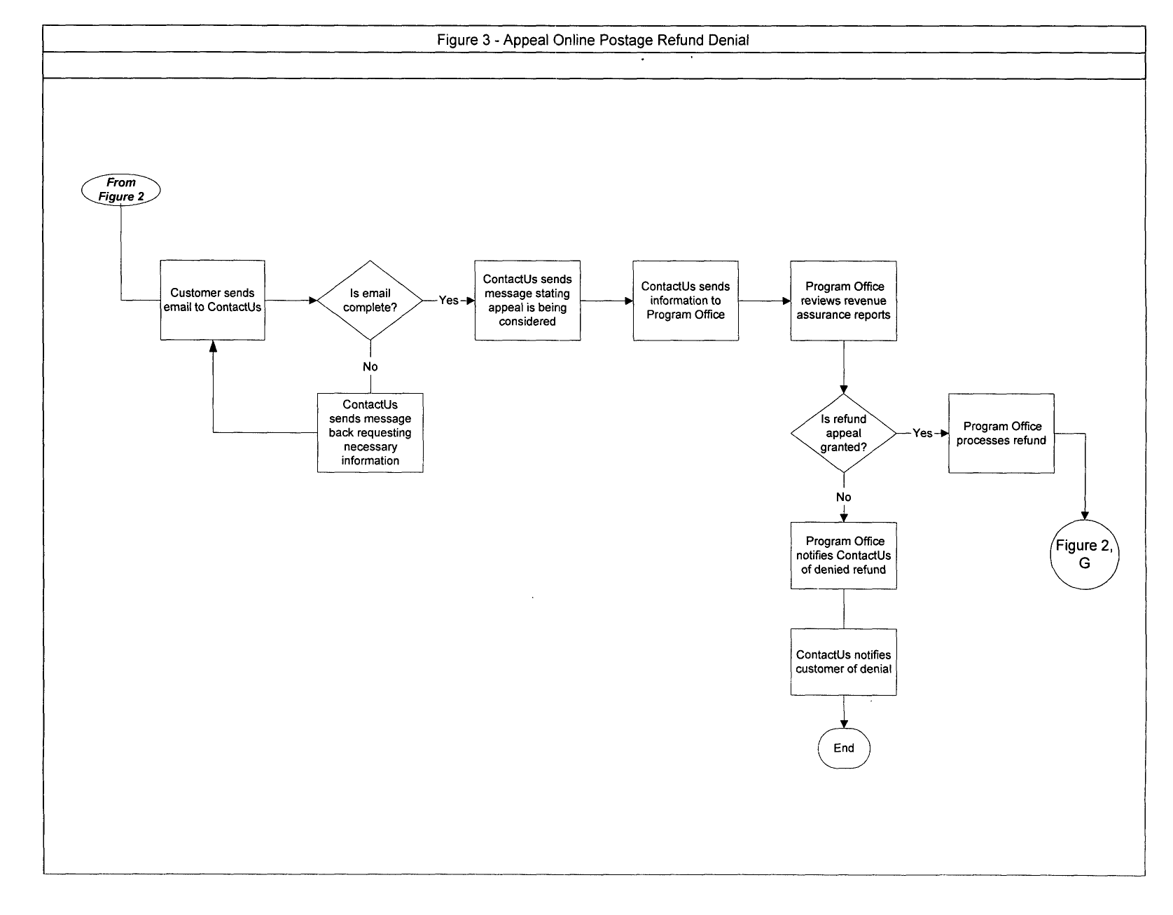

It will be preferred to process the information provided for fraud-prevention reasons. For example, it is preferred, in the interest of verifying fraud, to verify that an undue period of time has not passed since the postage purchase transaction. (The amount of time that would be considered to constitute an undue period may depend on administrator preference, but a period of between about 1 and 30 days is preferred, with a period of about 10 days being considered optimal.) The information should further be processed to ensure that the particular IBI associated with the tracking/label number and/or transaction number was not previously voided or refunded, and/or that there is not an active scan event for the tracking/label number. If the customer does not meet fraud-prevention criteria, then the system denies the request by displaying a message on the screen that the request is denied. (FIG. 3, discussed below, describes an appeal process that may be permitted for persons who have had their refund requests denied.)

If the fraud-prevention criteria are satisfied, the system should further process the request. Preferably, this involves queuing the request for a designated period, for example seven days, to check for scan events. (This period may be varied, as desired, and may be less than seven days or greater than seven days.) If there is a scan event within the designated period, the system then denies the request and notifies the customer, preferably via e-mail. If there is no scan event by the end of the designated period (for example, by day eight), the system should approve the request, credit the account, flag the record in the system (in the event that a subsequent attempt is made to obtain a refund for the same transaction) and send approval confirmation to the customer.

It may be preferred to provide additional security steps, to prevent fraud or other misuse of a refund method as herein described. For example, it is desired to track users who repeatedly submit improper refund requests. Among other things, such tracking would permit the suspension of postage printing capabilities for such users, and/or the reporting of the identity of such a user to a body capable of taking further action against the user for submitting improper refund requests. It should be noted that provision can be made for such a user to repay the amount they owe at, for example, a local post office, or in the preferred embodiment, online. This may also reactivate their ability to participate in purchase transactions.

Referring now to FIG. 3, it is noted that it is possible to provide an appeal process, whereby a customer who has received a rejection of a refund request may appeal such rejection. Preferably, the process is initiating by the customer contacting the refunding authority at “Contact Us” via e-mail, and submitting complete information regarding the transaction for which a refund is sought. The refunding authority, perhaps through a Program Office or the like, processes the appeal using desired criteria. In the event the appeal is denied, that decision should be communicated to the customer, preferably via e-mail. In the event the appeal is granted, the refund should then be processed using the existing criteria of reviewing scan activity and label status.

The embodiment of an online refund method as shown in FIG. 2 is quite versatile in its ability to process the refund request promptly and virtually eliminating fraud. It promotes excellent customer service, is efficient, and would save costs.

Though the software and the process was designed to provide this service to the Postal Service customers for online shipping labels with PC Postage™ service, its use is not limited to the postal or PC Postage™ transactions alone. It may be utilized by other postal organizations or for particular postal transactions other than those listed herein, provided that a tracking number is associated with IBI evidencing the postage for which a refund is later sought. The method herein described may also be utilizable in other types of refund transactions, for example to permit a customer who has made an in-person, online, mail order or other retail purchase of a good or service to apply for a refund online, whether the transaction involves a commercial entity, a non-profit organization, or a governmental agency.

Other embodiments consistent with the present invention will be apparent to those skilled in the art from consideration of the specification and the practice of the invention disclosed herein. It is intended that the specification and the examples be considered exemplary only with the true scope of the invention being indicated by the following claims and equivalents.

We claim:

1. A method of processing refunds online comprising the steps of:
a purchaser making a purchase;
assigning identifying information to said purchase;
said purchaser seeking a refund for said purchase associated with said identifying information;
said step of seeking said refund further comprising the steps of:
said purchaser logging on to an online refund system;
said purchaser providing to said online refund system said identifying information;
said online refund system verifying said refund request; and
said online refund system providing a refund for said purchase to said purchaser.

2. The method of claim 1 wherein said purchase is made online.

3. The method of claim 1 wherein said identifying information includes a tracking number.

4. The method of claim 3 wherein said identifying information further includes a transaction number.

5. The method of claim 1 further comprising the step of said purchaser providing to said online refund system information concerning said purchaser, including a user ID and a password.

6. The method of claim 3 wherein said step of verifying said refund request includes the step of determining whether an undue period of time has passed from said purchase.

7. The method of claim 3 wherein said step of verifying said refund request includes the step of determining whether there has been a scan event associated with said postage.

8. The method of claim 3 wherein said step of verifying said refund request includes the step of queuing said request for a period of time, and determining that no scan event occurs during said period of time, prior to issuing a refund.

9. The method of claim 8 wherein said period of time is seven days.

10. The method of claim 1 wherein said step of verifying said refund request includes the step of determining whether there has been a prior refund request associated with said purchase.

11. The method of claim 3 wherein said step of verifying said refund request includes the step of determining whether said purchase for which a refund has been sought has previously been voided.

12. The method of claim 1 further comprising the step of tracking an identity of a purchaser who submits a plurality of improper refund requests.

13. The method of claim 12 further comprising the step of suspending purchase privileges of said purchaser who submits a plurality of improper refund requests.

14. The method of claim 12 further comprising the step of report said identity of said purchaser who submits a plurality of improper refund requests.

15. The method of claim 1, further comprising the step of permitting a purchaser who has received a rejection of a refund request to appeal said rejection.

16. A method of processing refunds online comprising the steps of:
accepting a purchase from a purchaser;
wherein said purchase is of postage and wherein said purchase is evidenced by identifying information;
accepting a refund request from said purchaser for said purchase associated with said identifying information;
said step of accepting said refund request further comprising the steps of permitting said purchaser to:
log on to an online refund system;
provide to said online refund system information concerning said purchaser, including a user ID and a password; and
provide to said online refund system said identifying information concerning said purchase;
verifying said refund request;
wherein said step of verifying said refund request includes the step of determining whether there has been a scan event associated with said postage;
wherein said step of verifying said refund request further includes the step of determining whether there has been a prior refund request associated with said purchase; and
said online refund system providing a refund for said purchase to said purchaser.

17. The method of claim 16 wherein said identifying information includes a tracking number.

18. The method of claim 17 wherein said identifying information further includes a transaction number.

19. The method of claim 16 wherein said step of verifying said refund request includes the step of determining whether an undue period of time has passed from said purchase.

20. The method of claim 16 wherein said step of verifying said refund request includes the step of queuing said request for a period of time, and determining that no scan event occurs during said period of time, prior to issuing a refund.

21. The method of claim 20 wherein said period of time is seven days.

22. The method of claim 16 wherein said step of verifying said refund request includes the step of determining whether said purchase for which a refund has been sought has previously been voided.

23. The method of claim 16 further comprising the step of tracking an identity of a purchaser who submits a plurality of improper refund requests.

24. The method of claim 16 further comprising the step of suspending purchase privileges of said purchaser who submits a plurality of improper refund requests.
